(19) United States
(12) Patent Application Publication
(10) Pub. No.: US 2026/0258927 A1
(43) Pub. Date: Sep. 3, 2026

(54) HEADLAMP FOR VEHICLES

(71) Applicant: HELLA GMBH & CO. KGAA, Lippstadt (DE)

(72) Inventors: Ulrich-Christian Knaack, Paderborn (DE); Christian Koerdt, Geseke (DE); Ingo Möllers, Rietberg (DE); Peter Rausch, Münster (DE); Sonja Seibt, Warburg (DE)

(21) Appl. No.: 19/653,768

(22) Filed: Apr. 21, 2026

Related U.S. Application Data
(63) Continuation of application No. PCT/EP2024/078304, filed on Oct. 9, 2024.

(30) Foreign Application Priority Data
Oct. 23, 2023 (DE) 102023129028.2

(51) Int. Cl. F21S 41/663; F21S 41/143; F21S 41/153; F21S 41/265; F21V 5/00; F21W 102/10

(52) U.S. Cl. CPC F21S 41/663; F21S 41/143; F21S 41/153; F21S 41/265; F21V 5/008; F21S 2243/00; F21W 2102/10

(57) ABSTRACT

The invention relates to a vehicle headlamp including a light source unit containing a plurality of light sources and an optical unit containing a plurality of imaging elements for generating a light distribution in a region in front of the vehicle. The light source unit has a predefined dimension. The optical unit exhibits a level of distortion such that the light distribution, at a predefined maximum intensity within a region of the light distribution, has an illumination width that is greater than an illumination width that results when the light source unit is imaged by an optical unit with distortion-free imaging.

### CROSS-REFERENCE TO RELATED APPLICATIONS

This application is a continuation of PCT/EP 2024/074304, filed Oct. 9, 2024, which claims prioroity to German Patent Application DE 10-2023-129-028.2, filed Oct. 23, 2023, the disclosures of which are incorporated by reference in their entirety.

### FIELD OF THE INVENTION

The invention relates to a headlamp for vehicles, said headlamp including a light source unit containing a number of light sources, and an optical unit containing a number of imaging elements for generating a light distribution in a region in front of the vehicle, wherein the light source unit has a predefined dimension.

The invention further relates to a method for the basic design of a headlamp, which has a light source unit and an optical unit for generating a predefined light distribution.

### BACKGROUND OF THE INVENTION

WO 2017/106891 A1 discloses a headlamp for vehicles that has a light source unit and an optical unit for generating a predefined light distribution. The light source unit has an mxn matrix of light sources that can be controlled individually. To reduce unwanted distortion, the rows of light sources in the light source unit have a curved profile.

In such direct-imaging headlamp systems, a fixed defined size of light source units containing a specific number of light sources is often installed. As a result of the fixed defined size of the light source unit, a predefined illumination region, in particular, an illumination width, can only be adjusted via the optical unit. In an optical unit with distortion-free or minimal distortion imaging, enlarged imaging of the light source unit is inversely proportional to the focal length of the optical unit, while the maximum achievable intensity of a light source imaged by the optical unit in the light distribution increases quadratically with the focal length. When a predefined illumination width of the light distribution is to be achieved, this usually requires a reduction in the focal length f. However, this reduction in the focal length f results in a quadratic reduction of the maximum intensity value in a region of the light distribution.

### SUMMARY OF THE INVENTION

The object of the present invention is therefore to provide a headlamp for vehicles and a method for basic design of the headlamp, such that optical units can be provided in a simple manner for a light source unit of fixed dimensions, wherein an increase in the illumination width is accompanied by no reduction, or only a slight reduction, in the maximum intensity of a region in the light distribution.

To achieve this object, the optical unit exhibits such a high level of distortion that the light distribution that the light distribution, at a predefined maximum intensity, in a region within said light distribution, has an illumination width that is greater than an illumination width that results when the light source unit is imaged by an optical unit with distortion-free imaging.

Advantageously, the invention allows a wide illumination region while maintaining a maximum possible intensity value in the light distribution to the greatest possible extent. According to the invention, a large illumination width is achieved by distorting the optical unit. As compared with a non-distorted optical unit, this achieves a greater illumination width, on the one hand, and a minimum value for a maximum intensity region of the light distribution, on the other hand. The basic idea of the invention is to achieve an increase in the illuminated region or imaging region, wherein the otherwise associated reduction of the maximum intensity within the light image is compensated for by the fact that the increase of the illuminated region is achieved through targeted distortion of the optical unit. Advantageously, the invention makes it possible to provide different illumination widths with approximately the same maximum intensity within the light image by simply replacing the optical unit, while the headlamp is otherwise of identical design, with the light source unit and the predefined distance between the light source unit and the optical unit remaining the same. The invention thus provides a simple basic design for the headlamp, wherein the predefined requirements imposed on the headlamp are met by the selective mounting of optical units having different distortions.

According to a further embodiment of the invention, the distortion of the optical unit is at least more than 5%. This ensures that the illumination width is significantly increased compared to a non-distorted optical unit.

According to a further embodiment of the invention, the distortion is designed as a pincushion distortion, so that with increasing distance from a central point, namely the optical axis, the distortion is increased compared to the optical unit without distortion.

According to a further embodiment of the invention, a distortion curve indicating the distortion over a path from an optical axis is non-linear, in particular quadratic. Advantageously, this allows the illumination width to be increased without reducing the maximum intensity value in a region of the light distribution.

According to a further development of the invention, the optical unit has a number of lens elements, wherein at least one lens element is designed as a fisheye lens element. This allows the pincushion distortion to be realized.

According to a further embodiment of the invention, the light source unit is arranged off-center or offset relative to the optical axis, so that an expansion of the light distribution occurs on a side opposite the lateral offset. For example, if the light source unit is offset horizontally to the left, the light distribution is offset laterally to the right by means of the optical unit, wherein the illumination width is greater than the illumination width of the headlamp in which the light source unit is arranged centrally. This asymmetrical positioning of the light source unit relative to the optical unit allows the illumination region or the illumination width to be further increased.

According to a further embodiment of the invention, the light source unit has a plurality of light sources arranged like a matrix and individually controllable, so that the desired light distribution is generated by corresponding control of the light sources. The maximum illumination width is achieved when all light sources are switched on.

According to a further embodiment of the invention, the optical unit is formed by a lens device having a number of lenses. The light source unit does not have any primary optics. The light emitted by the light source unit strikes the lens device directly, resulting in a direct-imaging optical unit.

To achieve the object, the invention includes a method. The particular advantage of this method is that it allows for the simple development of a basic design of a headlamp to meet various requirements regarding a predefined illumination region. Merely by selecting an optical unit from a group of optical units with different distortions, a headlamp can be configured to achieve the desired maximum illumination region or maximum illumination width. The illumination region or the illumination width can thus be varied while maintaining the same maximum intensity value in the light distribution. The inverse relationship between enlargement of the image and maximum achievable intensity in the light distribution is eliminated by the use of positive distortion. The positive distortion causes the light distribution to spread out.

### BRIEF DESCRIPTION OF THE DRAWING

Exemplary embodiments of the invention are explained in more detail below with reference to the drawings. In the drawings:

FIG. 1 is a schematic representation of a headlamp with a selection of different optical units, each of which exhibits a different positive distortion;

FIG. 2 is a distortion curve of the optical unit, indicating the percentage of the distortion as a function of a distance from an optical axis of the optical unit; and

FIG. 3 is a schematic representation of an asymmetrical positioning of a light source unit.

### DETAILED DESCRIPTION OF THE CURRENT EMBODIMENT

A headlamp for vehicles according to the invention substantially has a light source unit 1 and an optical unit 2 for generating a predefined light distribution L1, L5, which are arranged in a common housing G. The light source unit 1 is arranged at a constant distance a from the optical unit 2.

The light 3 emitted by the light source unit 1 is directly imaged by the optical unit 2 to produce the light distribution L1, L5 in a region 13 in front of the vehicle.

In the present exemplary embodiment, the optical unit 2 is designed as a lens device having a predefined number of lens elements 4 (imaging elements).

According to an alternative embodiment of the invention not shown, the optical unit 2 may also be designed as a reflector device. Substantially, the optical unit 2 is designed such that light striking it is imaged into the region 13 in front of the vehicle in accordance with the predefined light distribution L1, L5.

The light source unit 1 comprises a plurality of light sources 5 arranged like a matrix in columns and rows. The light sources 5 are preferably designed as LED light sources arranged on a chip.

A control unit 6 is provided for controlling the individual light sources 5, wherein said control unit generates a corresponding control signal 7, by means of which a defined selection of the light sources 5 defined depending on the specified light distribution L1, L5 is switched on or off.

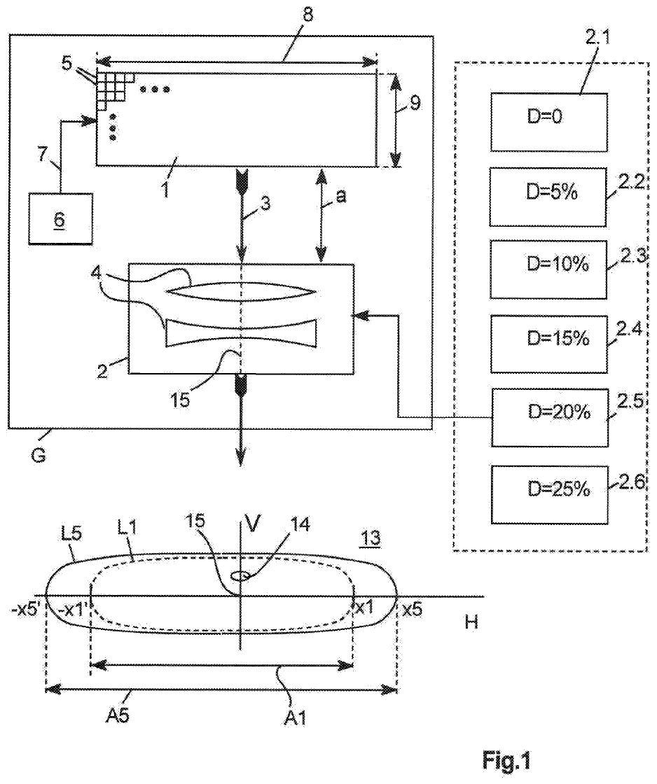

The light source unit 1 has a predefined dimension with a predefined width 8 and a predefined height 9. For reasons of simplification, FIG. 1 shows the front view of light source unit 1 that consists of the mxn matrix of light sources 5.

A selection of optical units 2.1, 2.2, 2.3, 2.4, 2.5, 2.6 is available for the basic design of the headlamp, from which an optical unit is selected depending on the predefined requirements.

For example, if a light distribution L1 is desired that has a relatively narrow illumination width A1 between a horizontal value X1 and a negative horizontal value −XT on the horizontal axis H, the optical unit 2.1 with the distortion D=0 is selected and mounted. In a central region 14, this light distribution L1 has a maximum intensity Iₘₐₓ of approximately 100 Ix.

It is assumed that the illumination width A1 always refers to the maximum illumination width, for example, when all light sources 5 of light source unit 1 are switched on.

If a light distribution L5 with an increased illumination width A5 is to be generated, the optical unit 2.5 is selected, which has a positive distortion of D=20. The illumination width A5 extends between a positive horizontal value X5 and a negative horizontal value −X5′, wherein, for example, X5 may correspond to the emission angle of 14° and −X5′ may correspond to the emission angle of −22° as the corresponding maximum horizontal emission angles. As can be seen in FIG. 1, the central region 14 continues to exhibit the maximum intensity Iₘₐₓ, wherein the value may be, for example, approximately 100 Ix.

The invention thus allows light distributions L1, L5 to be generated in the manner of a modular system exclusively by selecting and/or changing optical elements 2.1, 2.2, 2.3, 2.4, 2.5, 2.6 with different positive distortion, which substantially only differ in terms of differently sized illumination widths A1, A5, but not in terms of different intensity Iₘₐₓ within the light distribution L1, L5.

In the present exemplary embodiment, the group consists of six different optical units 2.1, 2.2, 2.3, 2.4, 2.5, 2.6, which differ in that they cover a range of positive distortions between 0% and 25%, wherein the distortion difference is 5%.

These distortions are designed as pincushion distortions, which means that when imaging a square light source, corner regions in particular are imaged further stretched outwards from the center.

At least one lens element 4 of the optical units 2.1 to 2.6 is designed as a fisheye lens element in order to achieve the imaging function of a fisheye, in which the light source unit 1, that is perpendicular to the optical axis 15, is imaged disproportionately.

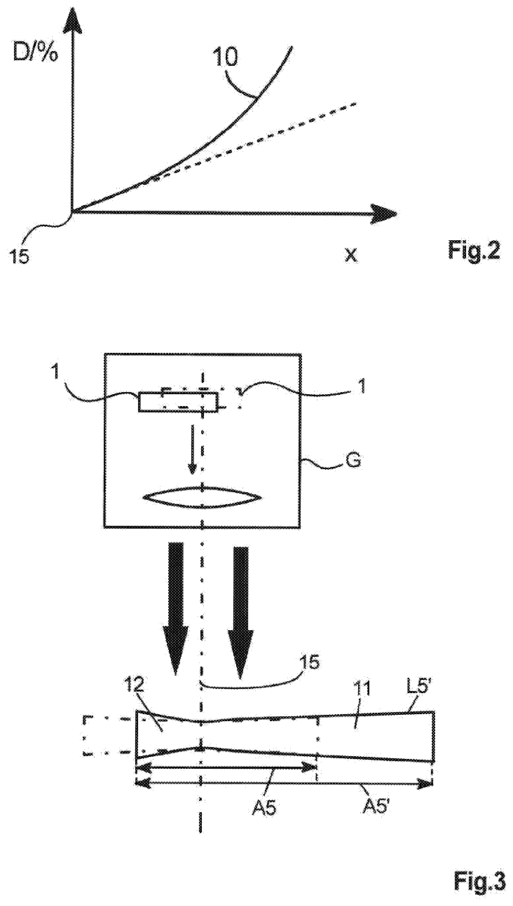

FIG. 2 is a distortion curve 10 that exhibits a quadratic, and thus a non-linear, profile, in which the imaging angle increases or a greater width is illuminated with greater distance x to an optical axis 15. When imaged by the optical unit 2.1 without distortion, the image would be linear over the length x, see dashed line.

According to another embodiment of the invention, an additional increase or adjustment of an increased illumination width may be achieved. In the embodiment shown in FIG. 1, the light source unit 1 is arranged symmetrically with respect to the optical axis 15. Imaging is performed using optical unit 2.5 to produce a light distribution L5 with an illumination width A5. To further increase the illumination width A5, according to the alternative embodiment of the invention, the light source unit 1 is arranged laterally offset with respect to the optical axis in the horizontal X-direction, such that the light source unit 1 occupies an asymmetrical position relative to the optical axis 15; see the solid line in FIG. 3. Solely by laterally offset arrangement of the light source unit 1, a light distribution L5′ is generated that has an illumination width A5′, which is greater than the illumination width A5 when the light source unit 1 is arranged centrally relative to the optical axis 15. The illumination width is shifted and expanded to the side of the optical axis 15 opposite the offset of the light source unit 1. The resulting light distribution L5′ is not symmetric with respect to the optical axis 15, as was the case with light distribution L5. Instead, a first section 11 of the light distribution L5′ is located on a side of the optical axis 15 opposite the light source unit 1, which has a greater increase in length than a second section 12 of the light distribution L5′, which adjoins the side of the optical axis 15 facing the light source unit 1.

The asymmetric positioning or off-center positioning of the light source unit 1 ensures further widening of the illumination distribution without reducing the maximum intensity Iₘₐₓ within the light distribution L5′.

By individually controlling the light sources 5, for example, based on camera data that detects other objects in the region in front of the vehicle, the light sources can be controlled in such a way that light spots are imaged into the region in front of the vehicle, which together form the light distribution L5′, wherein regions of the light distribution are dynamically omitted where a traffic object is currently located. This prevents unwanted glare for the other road users.

### LIST OF REFERENCE SIGNS

1 light source unit 2.1-2.6 optical unit
3 light
4 lens element
5 light sources
6 control unit
7 control signal
8 width
9 height
10 distortion curve
11 first section
12 second section
13 region in front of the vehicle
14 region
15 optical axis
L1, L5, L5′ light distribution
H horizontal
X1, X5 horizontal value
−X1′, −X5′ negative horizontal value
Iₘₐₓ maximum intensity
A1, A5, A5′ illumination width
x distance/path
D distortion

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A headlamp for a vehicle, comprising:
a light source unit including a plurality of light sources; and
an optical unit including a plurality of imaging elements configured to generate a light distribution in a region in front of the vehicle,
wherein the light source unit has a predefined dimension, and wherein the optical unit exhibits a level of distortion such that the light distribution, at a predefined maximum intensity within a region of the light distribution, has an illumination width that is greater than an illumination width that results when the light source unit is imaged by an optical unit with distortion-free imaging.

2. The headlamp of claim 1, wherein the distortion of the optical unit is greater than 5%.

3. The headlamp of claim 1, wherein the optical unit is selected from a group of optical units that exhibit positive distortion.

4. The headlamp of claim 1, wherein the distortion of the optical unit is a pincushion distortion.

5. The headlamp of claim 1, wherein the distortion of the optical unit is selected such that the maximum intensity in the region of the light distribution is equal in magnitude to a maximum intensity obtained when imaging with an optical unit without distortion.

6. The headlamp of claim 1, wherein a profile of a distortion curve over a path is non-linear.

7. The headlamp of claim 6, wherein the profile is quadratic.

8. The headlamp of claim 1, wherein the optical unit includes a plurality of lens elements as the imaging elements, and at least one of the lens elements is a fisheye lens element such that the optical unit has a fisheye imaging function in which the light source unit that is perpendicular to an optical axis is imaged disproportionately.

9. The headlamp of claim 1, wherein the light source unit is arranged laterally offset from a central position relative to an optical axis such that the illumination width of the light distribution is increased.

10. The headlamp of claim 1, wherein the light distribution extends further on a side of an optical axis opposite the light source unit than on a side of the optical axis facing the light source unit.

11. The headlamp of claim 1, wherein the light sources are arranged in a matrix on a substrate.

12. The headlamp of claim 1, wherein the optical unit is formed exclusively by a lens device.

13. The headlamp of claim 1, wherein the light sources are individually controllable and each light source is imaged by a lens device into a light spot of the light distribution, the light spots overlapping to form the light distribution.

14. A method for designing a headlamp having a light source unit and an optical unit for generating a predefined light distribution, the method comprising selecting and mounting one of a plurality of optical units having different positive distortions depending on a predefined illumination width.

15. The method of claim 14, wherein the same light source unit and a selected optical unit from the plurality of optical units having different distortions are installed at a same distance from one another.
